(19) United States
(12) Patent Application Publication
(10) Pub. No.: US 2019/0258114 A1
(43) Pub. Date: Aug. 22, 2019

(54) DISPLAY APPARATUS AND METHOD

(71) Applicant: SAMSUNG ELECTRONICS CO., LTD., Suwon-si (KR)

(72) Inventors: Oh Yun KWON, Seoul (KR); Do Won HEO, Suwon-si (KR)

(73) Assignee: SAMSUNG ELECTRONICS CO., LTD., Suwon-si (KR)

(21) Appl. No.: 16/345,983

(22) PCT Filed: Aug. 24, 2017
(86) PCT No.: PCT/KR2017/009233

§ 371 Date: Apr. 29, 2019

(30) Foreign Application Priority Data
Oct. 31, 2016 (KR) 10-2016-0143188

(51) Int. Cl. G02F 1/1335; G09G 3/36; G09G 3/3208; H05B 33/08

(52) U.S. Cl. CPC G02F 1/133603; G02F 1/133611; G09G 2310/0237; G09G 3/3208; H05B 33/0845; G09G 3/36

(57) ABSTRACT

A display device includes a display unit outputting an image, a backlight unit controlling a backlight source of the display unit, a signal receiving unit receiving an image signal, an image processing unit processing the received image signal and transmitting the processed image signal to the display unit such that an image is capable of being output depending on a specified frequency, and a control unit controlling the backlight unit and the image processing unit to change at least one of a lighting time of the backlight source and the frequency depending on a feature of the received image signal.

### TECHNICAL FIELD

Various embodiments of the disclosure relates to a display device and method capable of adjusting at least one of a display backlight or a frame rate.

### BACKGROUND ART

The backlight of a display may be distinguished into a side light type and a direct type depending on a method of arranging light sources. Because the direct type directly radiates light throughout the front surface of the liquid crystal panel by arranging a plurality of light sources on the rear surface of the liquid crystal panel, the radiating light of the liquid crystal panel may be uniform and the luminance may be high.

Because the light source of the backlight is always driven and the display controls the light transmittance to display the image, a motion blurring phenomenon (afterimage) may occur due to the response speed of the liquid crystal element of the display.

### DISCLOSURE

### Technical Problem

The motion blurring phenomenon may be improved by a scanning method in which the backlight is sequentially turned on/off in the direction of a scanline, but the scanning method may cause a side effect that the luminance of the output image is lowered.

Various embodiments disclosed in the disclosure may provide a display device and method capable of adjusting a backlight and a synchronization signal in consideration of the feature of an input image.

### Technical Solution

In accordance with an aspect of the disclosure, a display device includes a display unit outputting an image, a backlight unit controlling a backlight source of the display unit, a signal receiving unit receiving an image signal, an image processing unit processing the received image signal and transmitting the processed image signal to the display unit such that an image is capable of being output depending on a specified frequency, and a control unit controlling the backlight unit and the image processing unit to change at least one of a lighting time of the backlight source or the frequency depending on a feature of the received image signal.

In accordance with another aspect of the disclosure, a display method by at least one processor includes receiving an image signal, analyzing a feature of a received image signal, and controlling at least one of a lighting time of a backlight of a display outputting the image signal or a frequency at which the image signal is output to a display, depending on the feature of the received image signal.

### Advantageous Effects

Various embodiments of the disclosure may adjust the display backlight and frame rate while an image is output.

### DESCRIPTION OF DRAWINGS

FIG. 1 is a configuration diagram illustrating an interface of a display device and a graphic device, according to an embodiment.

FIG. 2A is a configuration diagram of a display device, according to an embodiment.

FIG. 2B is a view for describing a backlight adjustment function, according to an embodiment.

FIG. 2C is a view illustrating a processor and a display module in detail, according to an embodiment.

FIG. 3 is a flowchart illustrating a method of executing a backlight adjustment function, according to an embodiment.

FIG. 4 is a flowchart illustrating a method of executing a free synchronization function, according to an embodiment.

FIG. 5 is a flowchart illustrating a display method according to an image feature, according to an embodiment.

### MODE FOR INVENTION

Hereinafter, various embodiments of the disclosure will be described with reference to accompanying drawings. However, it should be understood that the disclosure is not intended to be limited to a specific embodiment, but intended to include various modifications, equivalents, and/or alternatives of the corresponding embodiment. With regard to description of drawings, similar components may be marked by similar reference numerals.

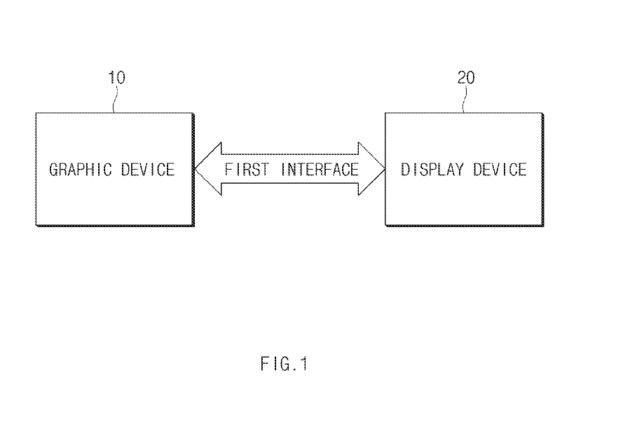

FIG. 1 is a configuration diagram illustrating an interface of a display device and a graphic device, according to an embodiment.

As illustrated in FIG. 1, a display device 20 according to an embodiment may interface with a graphic device 10.

According to an embodiment, the display device 20 may receive an image signal from the graphic device 10 or the like and may output an image according to the image signal, to a display.

According to an embodiment, the display device 20 may analyze the feature of the input image transmitted from the graphic device 10 and may control at least one of a backlight adjustment function or a free synchronization function to be turned on or off depending on the analysis result. For example, the feature of the image may include at least one of an average luminance level, a frame rate, or a frame rate change. When outputting an image to a display module, the display device 20 may perform at least one function of the backlight adjustment function or the free synchronization function. For example, the display device 20 may include at least one of a TV, a monitor, a mobile phone, a tablet, a notebook, or a Large Format Display (LFD).

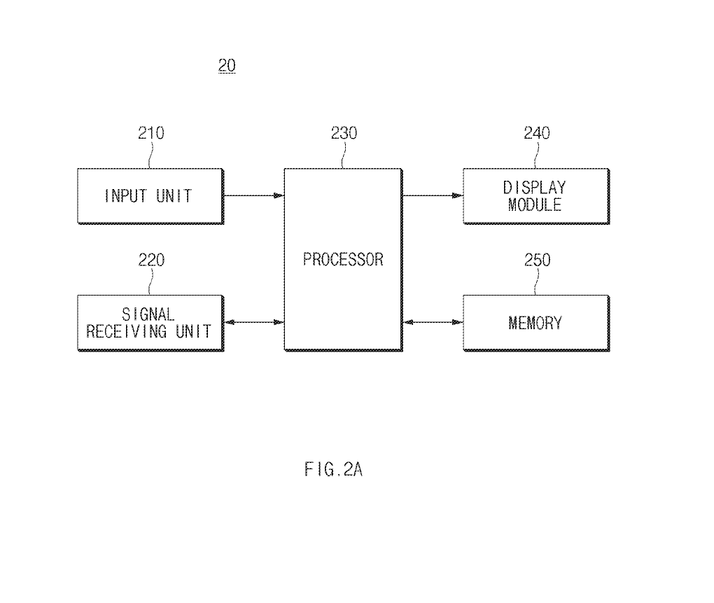

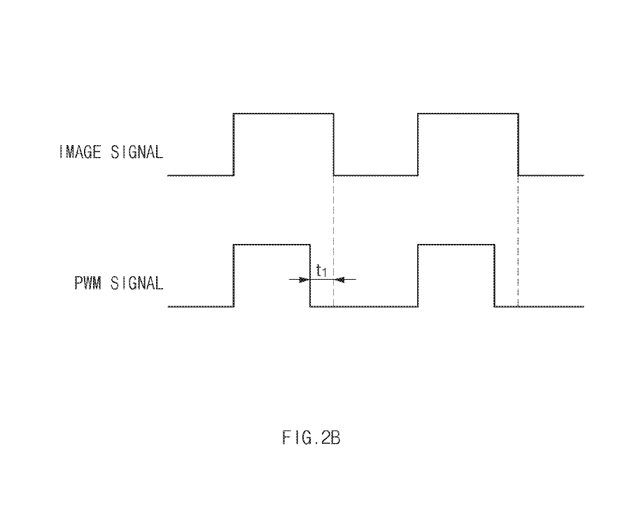

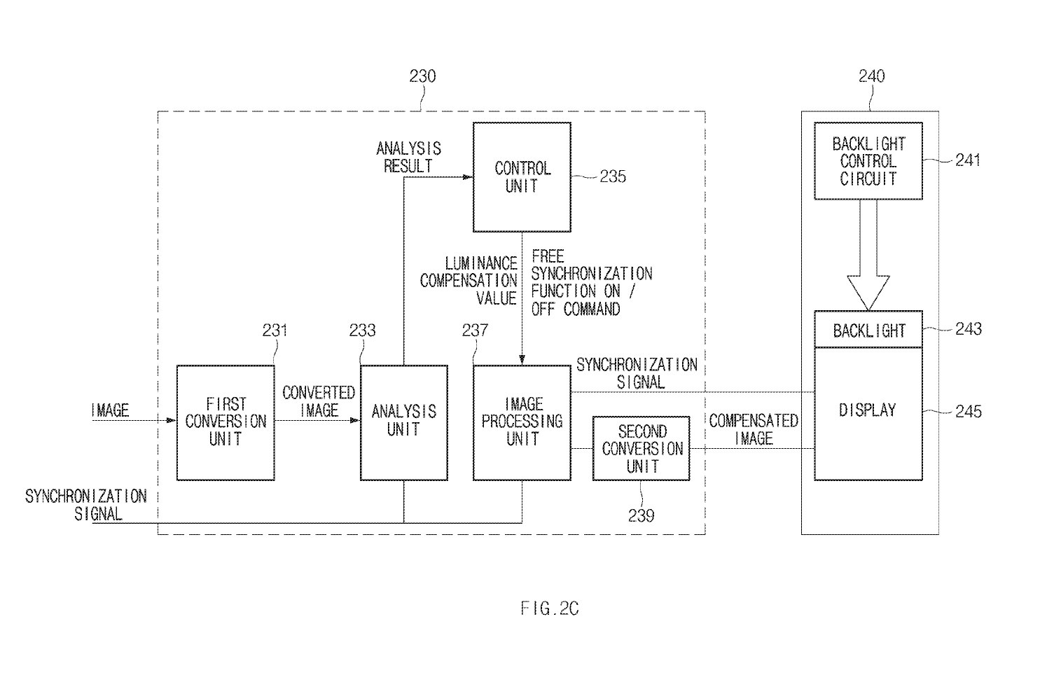

FIG. 2A is a configuration diagram of a display device, according to an embodiment. FIG. 2B is a view for describing a backlight adjustment function, according to an embodiment.

As shown in FIG. 2A, the display device 20 according to an embodiment may include an input unit 210, a signal receiving unit 220, a display module 240, a memory 250, and a processor 230. In an embodiment, a part of components may be omitted or an additional component may be further included. In an embodiment, some components may be combined to form one entity, which may identically perform functions of some components before the combination. The relation between the input and the output illustrated in FIGS. 2A and 2B may be exemplified for descriptive convenience. Accordingly, embodiments of the disclosure may not be limited thereto.

According to an embodiment, the input unit 210 may provide an interface for setting a control mode. For example, the control mode may include at least one of a free synchronization function or a backlight adjustment function.

For example, the input unit 210 may provide a user interface for setting a backlight adjustment function (hereinafter referred to as an ‘image quality mode’). The image quality mode may include at least one of an automatic mode or a manual mode. In an embodiment, the automatic mode may be a mode for automatically adjusting the turn-on/turn-off of the backlight adjustment function. For example, the automatic mode may be a mode for providing optimal game image quality based on the result of analyzing the feature of the input image. In an embodiment, the manual mode may be a mode for setting to manually turn on or off the backlight adjustment function. For example, the manual mode may be a mode in which the backlight adjustment function is applied in a fixed form depending on the feature (e.g., luminance level and FPS) of the input image. The manual mode may be set by selecting at least one genre of a game genre or a content feature, or the manual mode may be a mode for directly setting to turn on or off the backlight adjustment function.

According to an embodiment, the input unit 210 may provide an interface for setting of the display module 240. For example, the setting of the display module 240 may be an output resolution, an output frequency (e.g., 60 Hz), and the like.

According to an embodiment, the signal receiving unit 220 may provide a communication function with the graphic device 10. For example, the signal receiving unit 220 may receive an image transmitted from the graphic device 10 via an image interface such as HDMI, DVI, or the like and may convert the received image into a format recognizable by the processor 230. The image interface may receive at least one of an image or a sound source in various wireless communication methods such as Bluetooth, Wi-Fi, and the like.

According to an embodiment, the display module 240 may include at least one backlight source, a backlight control circuit, and a display. For example, the at least one backlight source may be a direct type of light source installed on the rear surface of the display or may be a side light type of light source. For example, the backlight control circuit may turn on or off the backlight of the display depending on the control signal (e.g., PWM signal) of the processor 230. For example, the backlight control circuit may include a boost circuit (LED driver) that boosts the power depending on the control signal for turning on the backlight. The display may output an image in synchronization with the synchronization signal according to the control of the processor 230. For example, the display may be a variety of displays such as LCD, OLED, PDP, and the like. The synchronization signal may be a synchronization signal according to the rendering cycle of the graphic device 10. The synchronization signal may be a synchronization signal according to the preset output frequency of a display. For example, the output frequency of the display may be set via the input unit 210.

According to an embodiment, the memory 250 may store information necessary to control a function including at least one of the free synchronization function or the backlight adjustment function. For example, the memory 250 may store a first threshold value, which becomes the basis of settings to turn on/off the backlight adjustment function for each game genre used in the manual mode, and settings to automatically turn on or off the backlight adjustment function and/or the second threshold value, which becomes the basis of settings to automatically turn on or off the free synchronization function. For example, the memory 250 may be a nonvolatile memory such as a flash memory or a hard disk or may be a volatile memory such as a RAM, or the like.

According to an embodiment, the processor 230 may identify the feature (e.g., average luminance level and frame rate) of the input image and may determine to turn on/off at least one function of the backlight adjustment function or the free synchronization function, based on the identified feature. For example, when the average luminance level is not less than the first threshold value, the processor 230 may turn on the backlight adjustment function; otherwise, the processor 230 may turn off the backlight adjustment function. The first threshold value may be, for example, 160 to 180 nit as a reference value for determining whether the luminance of the input image is high or low. For another example, when the frame rate is not less than the second threshold value, the processor 230 may turn on the free synchronization function; otherwise, the processor 230 may turn off the free synchronization function. The second threshold value may be, for example, ½ of the power frequency as a reference value for determining whether the frame rate of the input image is high or low.

According to an embodiment, as illustrated in FIG. 2B, the backlight adjustment function may be a function of reducing the lighting time of the backlight for the output period of each image frame of the input image to improve the motion blurring phenomenon. In FIG. 2B, the output period of each image frame is a positive section of the timing diagram displayed using each image signal, and the backlight lighting time may be a positive section of the timing diagram displayed using a PWM signal. In FIG. 2B, the period t1 in which the backlight lighting time is reduced may correspond to the motion size of the input image. For example, the processor 230 may identify the motion size of the input image and may decrease the duty ratio of the pulse width modulation within a specified backlight lighting time when the motion of the input image increases or may increase the duty ratio of the pulse width modulation within a specified backlight lighting time when the motion of the input image decreases. Accordingly, the lighting time of the backlight may be adjusted depending on the movement of the input image. For example, the specified backlight lighting time may be a period before outputting of the next image frame from the scan completion of each image frame to the display. The processor 230 according to an embodiment may reduce the lighting time of the backlight close to a point in time (or the scan completion time) when the output of the input image is terminated, in the PWM signal for turning on the backlight, thereby improving the motion blurring phenomenon.

According to an embodiment, when the backlight adjustment function is set to be turned on, as described above, the processor 230 may control the duty ratio of pulse width modulation. On the other hand, when the backlight adjustment function is set to be turned off, the processor 230 may not control the duty ratio of pulse width modulation.

According to an embodiment, the display device 20 may change and output the frame rate of the image, which is received from the graphic device 10, to a specified frame rate of the display device 20. The specified frame rate may be set by default or may be a display frame rate (e.g., 60 Hz) specified by the user via the input unit 210. For example, when the free synchronization function is turned off, the processor 230 may output an image to a display 245 in synchronization with the specified display frame rate (e.g., 60 Hz).

According to an embodiment, when the free synchronization function is set to be turned on, the processor 230 may not adjust the frame rate of the image transmitted from the graphic device 10, but output the image to the display 245 depending on the frame rate according to the rendering cycle of the graphic device 10. For example, when the free synchronization function is set to be turned on, the processor 230 may output an image to the display 245 in synchronization with the synchronization signal of the input image. For example, the free synchronization function may be a function such as a free sync or G-sync function. As such, when the free synchronization function is set to be turned on, the image displayed on the display 245 may be changed in synchronization with the image rendering cycle of the graphic device 10. Accordingly, the processor 230 according to an embodiment may prevent a tearing phenomenon or a stirring phenomenon, using the free synchronization function. The tearing phenomenon may be a phenomenon in which a previous image frame and a present image frame coexist on a single screen as the present image frame is input to a display during the display of the previous image frame.

FIG. 2C is a configuration diagram illustrating a processor and a display module in detail, according to an embodiment.

As illustrated in FIG. 2C, according to an embodiment, the processor 230 may include a first conversion unit 231, an analysis unit 233, a control unit 235, a scalier 237, and/or a second conversion unit 239. At least one of the components of the processor 230 according to an embodiment may be omitted. For example, when an image of the YCbCr format is transmitted from the graphic device 10, the first conversion unit 231 may be omitted. A part of the components of the processor 230 may be integrated into one component. For example, the analysis unit 233 and the image processing unit 237 may be integrated into one component. Each component of the processor 230 may be at least one hardware module or may be a software module implemented by the at least one processor. For example, the function performed by each component included in the processor 230 may be performed by at least one processor or may be performed by a separate processor.

According to an embodiment, when the image from the graphic device 10 is an RGB format, the first conversion unit 231 may convert the RGB format to YCbCr format.

According to an embodiment, the analysis unit 233 may analyze the luminance level of the input image to analyze whether the luminance level of the input image is high or low. For example, the analysis unit 233 may calculate the average luminance level by averaging the luminance of each pixel of the input image and may determine whether the result of comparing the average luminance level of the input image with the first threshold value indicates that the average luminance level of the input image is not less than the first threshold value or is less than the first threshold value. The analysis unit 233 may analyze the luminance level of the input image, periodically or when a preset condition is satisfied.

According to an embodiment, the analysis unit 233 may analyze the frame rate of the input image to analyze whether the frame rate of the input image is high or low. For example, the analysis unit 233 may periodically measure the frame rate of the input image, using the synchronization signal (e.g., Vsync) of the input image and may compare the measured frame rate with the second threshold value to output the comparison result of whether the frame rate is not less than the second threshold value or is less than the second threshold value. The analysis unit 233 may analyze the frame rate of the input image, periodically or when a preset condition is satisfied.

According to an embodiment, the analysis unit 233 may analyze the change in the frame rate of the input image. For example, the analysis unit 233 may determine whether the frame rate of the input image is rapidly changed more than a threshold count (e.g., more than twice), which is set to be more than the first threshold percentage (e.g., 10% or more) based on an input power frequency (e.g., 50-60 Hz). When there is no change of the frame rate of the input image signal during the set threshold time, the analysis unit 233 may determine that the input image is a still image. Alternatively, when there is no change of each pixel value of the image frame during the set threshold time, the analysis unit 233 may determine that the input image is a still image. For example, the still image may be an image with no change of the motion and the luminance level.

According to an embodiment, the analysis unit 233 may measure the motion size of the input image, using the difference between the present frame and the past frame of the input image. When the luminance level is not less than the first threshold value, the analysis unit 233 may measure the motion size of the input image and may output a measured value of the motion size.

According to an embodiment, the analysis unit 233 may output at least one of the comparison result between the luminance level and the first threshold value, the comparison result between the frame rate and the second threshold value, the measurement result of the motion size, or the analysis result of the change of the frame rate. For example, the analysis result of the change of the frame rate may be whether the input image is a still image, whether the frame rate is rapidly changed, or the like.

According to an embodiment, the control unit 235 may control the analysis unit 233, the first and second conversion units 231 and 239, the image processing unit 237, or the like overall. The control unit 235 may determine to turn on/off at least one function of the backlight adjustment function, the free synchronization function, or the gain compensation function, based on the selected image quality mode and the analysis result from the analysis unit 233. For example, the control unit 235 may determine to turn on/off at least one of the backlight adjustment function or the free synchronization function, based on at least one of the analysis result of the luminance level and the frame rate from the analysis unit 233 or the image quality mode selected by the input unit 210.

According to an embodiment, the control unit 235 may determine to turn on/off at least one of the backlight adjustment function or the free synchronization function as illustrated in Table 1 below. For example, when the average luminance level of the input image is not less than the first threshold value, the control unit 235 may determine to turn on the free synchronization function. For another example, when the average luminance level of the input image is less than the first threshold value, the control unit 235 may determine to turn off the backlight adjustment function. For another example, when the frame rate of the input image is not less than the second threshold value, the control unit 235 may determine to turn on the free synchronization function; when the frame rate of the input image is less than the second threshold value, the control unit 235 may determine to turn off the free synchronization function. When an image of a low frame rate that is less than the second threshold value is input, the control unit 235 according to one embodiment may set the free synchronization function to be turned off, thereby improving the problem that the motion of the output image is unnatural due to the free synchronization function.

TABLE 1

| | Average luminance level | |
|---|---|---|
| | Luminance level ≥ | Luminance level < |
| Frame rate | First threshold value | First threshold value |
| FPS ≥ First threshold | Backlight adjustment | Backlight adjustment |
| value | function (◯) | function (X) |
| | Free synchronization | Free synchronization |
| | function(◯) | function(◯) |
| FPS < First threshold | Backlight adjustment | Backlight adjustment |
| value | function (◯) | function (X) |
| | Free synchronization | Free synchronization |
| | function(X) | function(X) |

According to an embodiment, the control unit 235 may set to turn on/off at least one of the free synchronization function or gain compensation function, which is applied by the image processing unit 237, depending on the image quality mode selected through the input unit 210 and the luminance level. For example, as illustrated in Table 1, the control unit 235 may set to turn on the backlight adjustment function and the sync adjustment function, when the luminance level is not less than the first threshold value and when the frame rate is not less than the second threshold value. However, when a user desires to improve motion blurring due to fast motion, for example, when the user sets to manually turn on the backlight adjustment function via the input unit 210, the image processing unit 237 may be directed to compensate the luminance of the input image in advance.

According to an embodiment, the control unit 235 may calculate the amount of luminance to be lost by the backlight adjustment function, based on the average luminance level of the input image. For example, the control unit 235 may identify the backlight lighting time to be reduced in response to the motion size of the input image and may calculate the amount of luminance to be lost depending on the backlight lighting time stored in the memory 250. The control unit 235 may determine a luminance compensation value of a maximum luminance (e.g., 255) or less in consideration of the amount of the luminance to be lost. For example, the amount of luminance to be lost may reduce the backlight lighting time in an image, in which the motion size is not changed, and may be determined by an experiment for visually identifying the degree of decrease in luminance. For example, the luminance compensation value may be determined by an experiment in which the image brightness in a state where the backlight adjustment function is turned on is adjusted to a level similar to the image brightness in a state where the backlight is turned off.

According to an embodiment, when the average luminance level of the input image is less than the second threshold percentage of the maximum luminance of an image (e.g., a specific percentage between 50% and 75%), the control unit 235 may set a luminance compensation value capable of increasing the luminance of the input image by the amount of luminance to be lost by the backlight adjustment function. According to another embodiment, when the average luminance level of the input image is not less than the second threshold percentage of the maximum luminance of an image, the control unit 235 may set the luminance compensation value to the maximum amount capable of compensating for the luminance value of each pixel.

According to an embodiment, when the frame rate of the input image is not changed for a set threshold time, the control unit 235 may determine to turn off the backlight adjustment function. The control unit 235 according to an embodiment may prevent the problem that the screen luminance is reduced as the backlight adjustment function is executed in a state where a normal document or a website in which there is no motion or luminance change is displayed in the display 245.

According to an embodiment, even though the frame rate of the input image is not less than the second threshold value, when the frame rate of the input image is changed by a specified level or more, the control unit 235 may set to turn off the free synchronization function. When the analysis result of the analysis unit 233 indicates that the change of the frame rate of the input image is great, the control unit 235 according to an embodiment may set to turn off the free synchronization function, thereby preventing a flicker phenomenon occurring while being coupled to stuttering. The stutter phenomenon may be a phenomenon in which the screen is stopped and then played while video is played. The flicker phenomenon may be a phenomenon in which the whole screen of the display 245 blinks due to the luminance change of an image.

According to an embodiment, the control unit 235 may adjust the on-period (or off-period) of the backlight based on the motion size of the input image when the backlight adjustment function is turned on. For example, when the backlight adjustment function is set to be turned on, the control unit 235 may decrease the duty ratio of a pulse width modulation when the motion of the input image increases, or the control unit 235 may increase the duty ratio of the pulse width modulation when the motion of the input image decreases. When the backlight adjustment function is set to be turned off, the control unit 235 may not control the duty ratio of pulse width modulation separately.

According to an embodiment, the image processing unit 237 may compensate for the luminance of each pixel of the input image by the luminance compensation value received from the control unit 235. For example, when the average luminance level of the input image is less than the second threshold percentage of the maximum luminance of an image (e.g., a specified percentage between 50% and 75%), the image processing unit 237 may increase the luminance of each pixel of the input image by the set luminance compensation value. For another example, when the average luminance level of the input image is not less than the second threshold percentage of the maximum luminance of an image, the image processing unit 237 may compensate for the luminance value of each pixel by the maximum amount capable of being compensated.

According to an embodiment, the image processing unit 237 may compensate for the contrast of an image, of which the luminance is compensated. For example, the contrast compensation may be performed by at least one of a histogram equalization method or a stretching method. When image saturation is expected, for example, when the average luminance level is not less than the second threshold percentage of the maximum luminance, the image processing unit 237 may compensate for the contrast of the image; otherwise, the image processing unit 237 may not compensate for the contrast of the image. The image processing unit 237 according to an embodiment may prevent the sudden saturation of the image and an unnaturalness phenomenon between image frames due to the luminance compensation of the image.

According to an embodiment, when the free synchronization function is turned on, the image processing unit 237 may output an image in response to the frame rate of the input image. The image processing unit 237 may change the synchronization signal of the display 245 in synchronization with the frame rate of the input image and may output an image to the display 245 in synchronization with the changed synchronization signal. The image processing unit 237 may output the changed synchronization signal (e.g., Vsync or the like) when outputting the image and may output the image to the display 245 in synchronization with the synchronization signal. Because the input image is generated by the graphic device 10, the image processing unit 237 according to an embodiment may output the image to the display 245 in response to the image rendering cycle of the graphic device 10.

According to an embodiment, when the free synchronization function is turned off, the image processing unit 237 may match the input image to the fixed frame rate to output the image to the display 245. As such, the image processing unit 237 according to an embodiment may output the fixed or changed synchronization signal and an image, of which the luminance is compensated (or of which the luminance is not compensated).

According to an embodiment, when an image quality mode is set to a manual mode by the input unit 210, the control unit 235 may control the execution of each of the backlight adjustment function and the free synchronization function, depending on the predefined table. For example, the control unit 235 may determine to turn on/off the backlight adjustment function by the predefined feature of content as illustrated in Table 2.

TABLE 2

| Game genre | Applying backlight adjustment function |
|---|---|
| Racing | ◯ |
| RPG | Δ |
| Sports | ◯ |
| RTS/FPS/Fighting | □ |

For example, the control unit 235 may determine to turn on or off the backlight adjustment function, depending on the game genre as illustrated in Table 2. When a game in which the frame rate of an image is great, for example, a racing game or a sport game is executed, while the corresponding game is executed, the control unit 235 may fixedly set to turn on the backlight adjustment function. For another example, when a game in which the change of a luminance level is great and in which there are a lot of relatively dark images, for example, a real-time strategy (RTS) game, a first-person shooter (FPS) game, or a fighting game is executed, while the corresponding game is executed, the control unit 235 may fixedly set to turn off the backlight adjustment function. For another example, when a roll playing game (RPG) is executed, the control unit 235 may set to turn on the backlight adjustment function when the average luminance level is not less than a first threshold value, or the control unit 235 may set to turn off the backlight adjustment function when the average luminance level is less than a first threshold value.

According to an embodiment, the image processing unit 237 may convert the resolution of the input image to the resolution set by the input unit 210.

According to an embodiment, the second conversion unit 239 may convert an image of an YCbCr format, which is compensated by the image processing unit 237, or the input image to an image of an RGB format and then may transmit the image of an RGB format to the display 245.

When the average luminance level of the input image is high (e.g., Table 1), the control unit 235 according to an embodiment may decrease a turn-on time of a backlight in response to the motion size of an image, thereby improving a motion blurring phenomenon and the control unit 235 according to an embodiment turns on or off the free synchronization function (e.g., Table 1) based on the frame rate of the input image, thereby preventing the motion of the image from being unnatural by the free synchronization function.

In embodiments, when the motion blurring phenomenon is improved by the backlight adjustment function, the symptom that the luminance of an output image is reduced may be compensated slightly. Embodiments may reduce the motion blurring phenomenon of the playback image while maintaining a proper luminance for a game depending on an image quality feature for each content, and thus may improve the user's satisfaction.

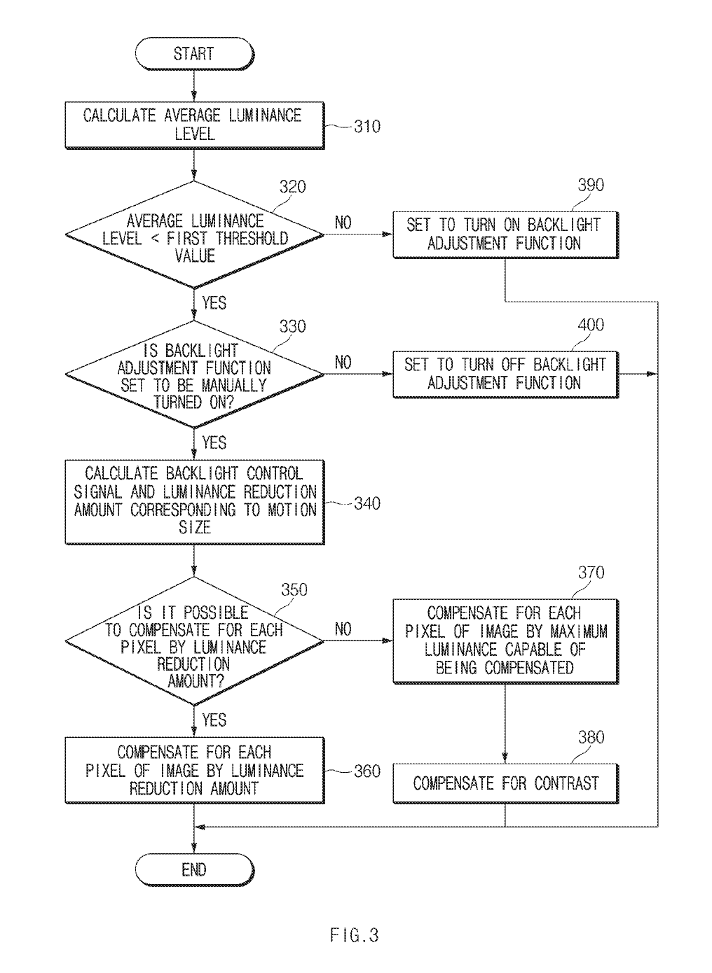

FIG. 3 is a flowchart illustrating a method of executing a backlight adjustment function, according to an embodiment.

Referring to FIG. 3, in operation 310, the processor 230 may calculate the average luminance level of an input image. For example, the processor 230 may calculate the average luminance level of the input image by averaging luminance values of all pixels of the input image.

In operation 320, the processor 230 may determine whether the average luminance level is less than a first threshold value. The first threshold value may be, for example, 160 to 180 nit as a reference value for determining whether the luminance of the input image is high or low.

In operation 330, the processor 230 may determine whether the backlight adjustment function is set to be manually turned on, via the input unit 210.

When the backlight adjustment function is set to be manually turned on at a point in time when the average luminance level is less than the first threshold value, in operation 340, the processor 230 may determine a backlight control signal and a luminance reduction amount, which correspond to the motion size of the input image. For example, the processor 230 may identify the motion size of the input image and then may determine a backlight control signal to reduce a backlight lighting time as the motion size increases. For another example, the processor 230 may determine a luminance compensation value to compensate for the amount of luminance to be lost due to the reduced backlight lighting time.

In operation 350, the processor 230 may determine whether it is possible to compensate for each pixel of an image by the determined luminance reduction amount. For example, when the average luminance level of the image is less than a third threshold value, the processor 230 may determine that it is possible to compensate for each pixel of an image by the determined luminance reduction amount. For example, the third threshold value may be a value of 50-70% of the maximum luminance.

When it is possible to compensate for each pixel of the image by the determined luminance reduction amount, in operation 360, the processor 230 may compensate for a pixel value of each pixel of the image by the determined luminance reduction amount.

When it is impossible to compensate for each pixel of the image by the determined luminance reduction amount, in operation 370, the processor 230 may compensate for the pixel value of each pixel of the image by the maximum luminance capable of being compensated. For example, the processor 230 may compensate for the luminance value by the determined luminance reduction amount with respect to a pixel, in which the sum of the luminance value of each pixel of the image and the luminance reduction amount is not greater than the maximum luminance. For example, the processor 230 may compensate for the luminance value of the corresponding pixel by the maximum luminance with respect to a pixel, in which the sum of the luminance value of each pixel of the image and the determined luminance reduction amount is greater than the maximum luminance.

In operation 380, the processor 230 may compensate for the contrast of an image in which the luminance is compensated. For example, the processor 230 may compensate for the contrast of an image in which the luminance is compensated by performing at least one of a histogram equalization method or a stretching method.

When it is determined that the average luminance level is not less than the first threshold value in operation 320, the processor 230 may set to turn on the backlight adjustment function in operation 390. The processor 230 may identify the motion size of the input image depending on the execution of the backlight adjustment function, and then may reduce the lighting time of the backlight when the motion size increases.

In operation 330, when the backlight adjustment function is not set to be manually turned on, in operation 400, the processor 230 may set to turn off the backlight adjustment function.

In an embodiment, the backlight adjustment function (e.g., impulsive scanning) may be performed on the input image when the luminance level of the input image is secured to a degree; when the luminance level of the input image is low, the luminance of the input image may be compensated at least somewhat when the backlight adjustment function needs to be performed, thereby improving the motion blurring phenomenon and slightly preventing the image luminance from being reduced.

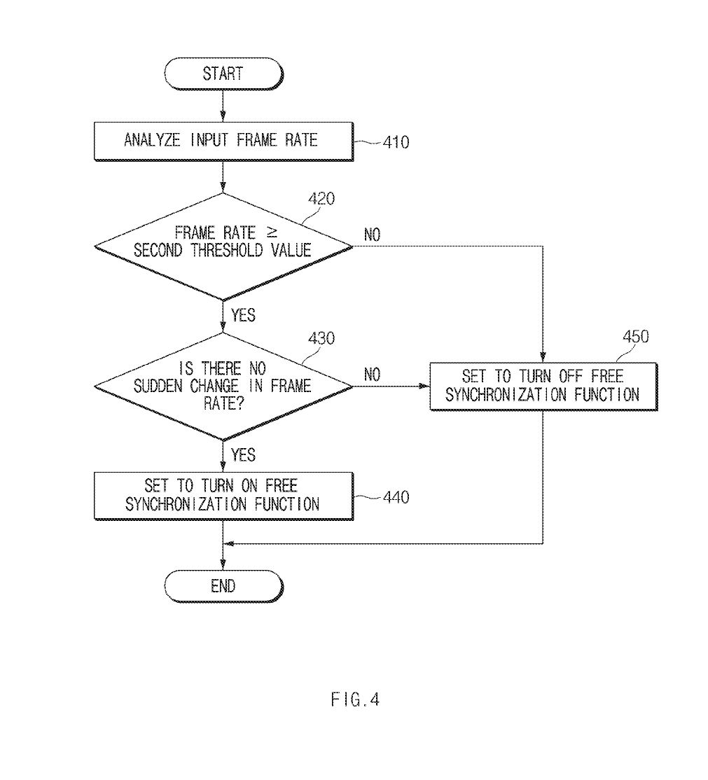

FIG. 4 is a flowchart illustrating a method of executing a free synchronization function, according to an embodiment.

Referring to FIG. 4, in operation 410, the processor 230 may analyze the frame rate of an input image. For example, the processor 230 may identify the frame rate and the frame change of the input image.

In operation 420, the processor 230 may determine whether the frame rate is not less than a second threshold value. The second threshold value may be, for example, ½ of the power frequency as a reference value for determining whether the frame rate of the input image is high or low.

When the frame rate is not less than the second threshold value, in operation 430, the processor 230 may determine whether there is no sudden change in the frame rate. For example, the processor 230 may determine whether the frame rate of the input image is rapidly changed more than the set threshold count (e.g., more than twice), which is set to be more than the first threshold percentage (e.g., 10% or more) based on an input power frequency (e.g., 50-60 Hz).

When there is no sudden change in the frame rate, in operation 440, the processor 230 may set to turn on the free synchronization function. When the free synchronization function is set to be turned on, in operation 440, the processor 230 may generate a synchronization signal Vsync in synchronization with a cycle at which the input image is scaled.

In operation 440, when the sudden change is present in the frame rate or when it is determined that the frame rate is less than the second threshold value, the processor 230 may set to turn off the free synchronization function in operation 450.

In an embodiment, the free synchronization function may be applied by identifying the frame rate and the change of the frame rate, thereby slightly preventing the unnaturalness of the motion, a flicker phenomenon, or the like due to the free synchronization function.

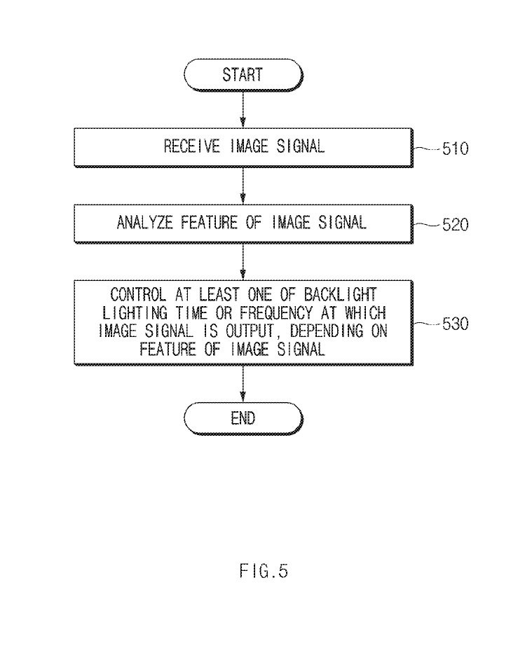

FIG. 5 is a flowchart illustrating a display method according to an image feature, according to an embodiment.

Referring to FIG. 5, in operation 510, the display device 20 may receive an image signal from the graphic device 10.

In operation 520, the display device 20 may analyze the feature of an image signal. For example, the feature of the image may include at least one of an average luminance level, a frame rate, or a frame rate change.

In operation 530, the display device 20 may control at least one of a backlight lighting time or a frequency at which an image signal is output to a display, depending on the feature of the image signal.

The term “module” used herein may include a unit, which is implemented with hardware, software, or firmware, and may be interchangeably used with the terms “logic”, “logical block”, “part”, “circuit”, or the like. The “module” may be a minimum unit of an integrated part or a part thereof or may be a minimum unit for performing one or more functions or a part thereof. The “module” may be implemented mechanically or electronically and may include, for example, an application-specific IC (ASIC) chip, a field-programmable gate array (FPGA), and a programmable-logic device for performing some operations, which are known or will be developed.

According to various embodiments, at least a part of an apparatus (e.g., modules or functions thereof) or a method (e.g., operations) may be, for example, implemented by instructions stored in a computer-readable storage media in the form of a program module. The instruction, when executed by a processor, may cause the processor to perform a function corresponding to the instruction. The computer-readable recording medium may include a hard disk, a floppy disk, a magnetic media (e.g., a magnetic tape), an optical media (e.g., a compact disc read only memory (CD-ROM) and a digital versatile disc (DVD), a magneto-optical media (e.g., a floptical disk)), an embedded memory, and the like. The one or more instructions may contain a code made by a compiler or a code executable by an interpreter. According to various embodiments, a module or a program module may include at least one of the above elements, or a part of the above elements may be omitted, or other elements may be further included.

According to various embodiments, operations executed by modules, program modules, or other elements may be executed by a successive method, a parallel method, a repeated method, or a heuristic method, or at least one part of operations may be executed in different sequences or omitted. Alternatively, other operations may be added. While the disclosure has been shown and described with reference to various embodiments thereof, it will be understood by those skilled in the art that various changes in form and details may be made therein without departing from the spirit and scope of the disclosure as defined by the appended claims and their equivalents.

1. A display device comprising:
a display unit configured to output an image;
a backlight unit configured to control a backlight source of the display unit;
a signal receiving unit configured to receive an image signal;
an image processing unit configured to process the received image signal and to transmit the processed image signal to the display unit such that an image is capable of being output depending on a specified frequency; and
a control unit configured to control the backlight unit and the image processing unit to change at least one of a lighting time of the backlight source or the frequency depending on a feature of the received image signal.

2. The display device of claim 1, wherein the control unit is configured to:
determine to turn on or off at least one function of a first function of reducing the lighting time of the backlight source or a second function of matching the frequency to a rendering cycle of the received image signal, in response to a motion size of the received image signal.

3. The display device of claim 2, further comprising:
an analysis unit configured to analyze an average luminance value of the received image signal,
wherein the control unit is configured to:
set to turn on or off the first function based on the average luminance value.

4. The display device of claim 3, wherein the analysis unit is configured to:
analyze a change in a frame rate of the received image signal, and
wherein the control unit is configured to:
when the frame rate of the received image signal is not changed during a specified threshold time, set to turn off the first function.

5. The display device of claim 3, further comprising:
an input unit,
wherein the analysis unit is configured to:
further analyze the frame rate of the received image signal, and
wherein the control unit is configured to:
in a state where it is identified that a luminance value and the frame rate of the received image signal are off conditions of the first function, depending on the analysis result of the analysis unit, when it is identified that the first function is set to be turned on, through the input unit, calculate a compensation value for compensating for an amount of luminance to be reduced depending on executing the first function.

6. The display device of claim 5, wherein the control unit is configured to:
when the average luminance value of the received image signal is less than a threshold percentage of a maximum luminance of each pixel of the received image signal, calculate the compensation value of the received image signal corresponding to the amount of luminance to be reduced; and
when the average luminance value of the received image signal is not less than the threshold percentage, calculate the compensation value for compensating for the received image signal by a maximum luminance capable of being compensated.

7. The display device of claim 6, wherein the image processing unit is configured to:
compensate for a luminance of the received image signal, using the compensation value;
generate a synchronization signal in response to a cycle for generating an image in which the luminance is compensated; and
output the compensated image to the display unit in synchronization with the synchronization signal.

8. The display device of claim 2, further comprising:
an analysis unit configured to analyze whether a frame rate of the received image signal is not less than a specified threshold value or is less than the specified threshold value,
wherein the control unit is configured to:
when the frame rate of the received image signal is not less than the specified threshold value, set to turn on the second function; and
when the frame rate of the received image signal is less than the specified threshold value, set to turn off the second function.

9. The display device of claim 2, further comprising:
an analysis unit configured to analyze a change in a frame rate of the received image signal,
wherein the control unit is configured to:
when it is identified that the change in the frame rate within a specified threshold time occurs more than a specified threshold count, which is set to be more than a specified threshold percentage, set to turn off the second function.

10. The display device of claim 2, further comprising:
an input unit,
wherein the control unit is configured to:
when at least one of a genre or a feature of an image is selected via the input unit, control at least one of the first and second functions to be turned on or off depending on the selected at least one of the genre or the feature; and
when the at least one function is set via the input unit to be turned on or off, control the at least one function to be turned on or off depending on settings via the input unit.

11. A display method by at least one processor, the method comprising:
receiving an image signal;
analyzing a feature of the received image signal; and
controlling at least one of a lighting time of a backlight of a display outputting the image signal or a frequency at which the image signal is output to the display, depending on the feature of the received image signal.

12. The method of claim 11, further comprising:
determining to turn on or off at least one of a first function of reducing the lighting time of the backlight source or a second function of matching the frequency to a rendering cycle of the received image signal, in response to a motion size of the received image signal,
wherein the controlling includes:
controlling the lighting time of the backlight source and the frequency depending on turning on or off at least one of the first function or the second function.

13. The method of claim 12, wherein the determining includes:
analyzing an average luminance value of the received image signal; and
when the average luminance value is less than a specified reference, determining to turn off the first function.

14. The method of claim 12, wherein the determining includes:
analyzing a frame rate of the received image signal;
when the frame rate of the received image signal is not less than a specified threshold value, determining to turn on the second function; and
when the frame rate of the received image signal is less than the specified threshold value, determining to turn off the second function.

15. The method of claim 12, wherein the determining includes:
analyzing a change in a frame rate of the received image signal; and
when the frame rate of the received image signal is not changed during a specified threshold time, determining to turn off the first function.
